(19) United States
(12) Patent Application Publication
(10) Pub. No.: US 2006/0127630 A1
(43) Pub. Date: Jun. 15, 2006

(54) Copper based alloys and optical media containing same

(75) Inventor: Heiner Lichtenberger, Williamsville, NY (US)

Correspondence Address: HISCOCK & BARCLAY, LLP, 2000 HSBC PLAZA, ROCHESTER, NY, 14604-2404, US

(73) Assignee: Williams Advanced Materials, Inc.

(21) Appl. No.: 11/195,542

(22) Filed: Aug. 2, 2005

Related U.S. Application Data
(60) Provisional application No. 60/599,660, filed on Aug. 6, 2004.

(51) Int. Cl. B32B 3/02

(52) U.S. Cl. 428/64.4

(57) ABSTRACT

An optical data recording and storage medium including at least one reflective layer formed from a copper alloy that contains, in addition to copper, about 0.1 to about 3.0 wt. %, based on the total weight of alloy, of samarium (Sm) and may further include from about 0.1 to about 5.0 wt. % titanium (Ti).

### CROSS-REFERENCE TO RELATED APPLICATION

This application claims priority to U.S. Provisional Patent application No. 60/599,660, filed Aug. 6, 2004.

### FIELD OF THE INVENTION

The present invention relates to optical data storage and recording media and more particularly to optical media containing reflective layers formed from copper-reactive metal alloys, specifically alloys of copper with the rare earth metal samarium.

### BACKGROUND OF THE INVENTION

Reflective metal thin films are used in creating optical storage media. These thin metal layers are sputtered onto transparent disks patterned to reflect a laser light source and/or containing a recording layer on which to record data which during recording will form patterns to be read by a laser light source. The reflected laser light is read as light and dark spots of certain length, converted into electrical signals, and transformed into images and sounds associated with music, movies, and data. All optical media formats, including compact disk (CD), laser disk (LD), and digital video disk (DVD), employ at least a single reflective metal layer, L1. More advanced optical media technology utilizes multiple reflective layers to increase the storage capacity of the media. For instance, many DVD's such as DVD 9, DVD 14, and DVD 18 contain two reflective layers, which enables two layers of information to be read from one side of the disk. The second layer, known as the L0 semi-reflective layer, must be thin enough, typically less than 10 nm, to allow the underlying L1 layer to be read, but it must still be sufficiently reflective, about 18% to about 30% reflectivity, to be read. The disk can further include one or more additional semi-reflective layers read from the same side as the L1 and L0 layers. The construction and reading methodology of a DVD containing two reflective layers is shown in FIG. 1.

When digital data is read from an optical storage medium, the lengths of the pits, typically of 9 different lengths, are read using an internal clock timing and converted into a high frequency electrical signal, which is truncated to generate square waves and transformed into a binary electrical data stream.

Variances in the length of the pits caused by molding the polycarbonate, by errors in a recording layer and/or by the incomplete metallization of the entire pit can cause errors in interpreting the data reflected by the laser. For optical media applications, the electronic circuits that interpret the data are specially designed to allow for a certain number of errors. There are four primary error indicators for optical media data. These critical parameters are categorized as:
1) PI—the total number of unreadable pits within a specified area; while industry standards allow for 280 defects, many companies hold this parameter to a maximum of 100
2) Jitter—the timing variation in pit or land length compared to the internal clock pulses; the industry maximum is 8%
3) Reflectivity—the percentage of laser light reflected from the pits; the industry standard is 18 to 30%
4) I-14—the variance in the longest pit length; the industry standard is less than 0.15% within one revolution and less than 0.33% within the disk.

After manufacturing, the data storage disks are scanned for errors, exposed to the environmental testing chamber, and subsequently re-analyzed for errors. Any failures at any testing stage, based on industry standards for error rates, or marked deterioration, even if not actually failing, after environmental testing will lead to rejections. The environmental testing demands a corrosion resistant material for the reflective metallizations. While a thickness of 20 nm of Al generally is adequate for the fully reflective layer as produced, a thickness of 40 nm may be required to provide adequate reflectivity after environmental exposure. Typically, about half of the original aluminum layer is transformed into transparent aluminum oxide during this environmental test. The semi-reflective layer is recognized to be somewhat more critical since its apparent thickness and reflecting qualities cannot change by more than about 10% of its original relative value during environmental exposure. In addition to the testing noted above, there is also a non-industry specification regarding UV or sunlight exposure, where, e.g., it has been found that disks made with copper alloys can discolor when subjected to sunlight.

Aluminum, gold, silicon, silver and copper alloys have been used to create reflective layers for optical storage media. Because of its low cost, excellent reflectivity and sputtering characteristics on polymeric materials, aluminum has been especially preferred metal for a reflective coating that is used almost exclusively whenever there is only one reflective data layer and is also used to form the fully reflective L1 layer on a two-layer DVD. However, aluminum oxidizes readily, and its reflectivity can be compromised upon environmental exposure. This oxidation prohibits the use of aluminum for all but the fully reflective layer, where it is deposited more heavily than the semi-reflective layer would allow. Gold and silicon were the first materials to be used for the semi-reflective layer in DVD construction, but both materials have significant drawbacks. Gold provides excellent reflectivity of red laser light, excellent sputtering characteristics, and superior corrosion resistance but is very costly. Silicon is also reflective and free from corrosion but does not sputter as efficiently as the other metals. Furthermore, silicon is brittle, and cracks may form during thermal cycling and mechanical flexing, which prevents delicate data from being read. U.S. Pat. No. 5,640,382 describes the construction of a DVD data storage disk, and U.S. Pat. No. 5,171,392 describes the use of gold and silicon for the semi-reflective data storage layer; the disclosures of these patents are incorporated herein by reference.

Silver, like gold, has excellent sputtering characteristics and reflectivity, but the corrosion resistance of pure silver is inadequate for it to be used as the semi-reflective layer by current quality standards. Considerable effort has been expended to make silver sufficiently corrosion resistant so that it can be used in thin layer, as described, for example, in U.S. Pat. Nos. 6,280,811, 6,292,457, and 6,351,446, the disclosures of which are incorporated herein by reference. These patents describe silver based alloys for optical media whose corrosion resistance is improved by the addition of other precious metals such as palladium, platinum, and gold, whereas still others, such as Japanese Patent Publications Nos. 02-192046, 07-105575, 09-212915, and 10-01179 also describe the addition to silver of small amounts of one or more of non-precious materials such as manganese, titanium, tungsten, copper, zinc and nickel, among others.

Still, for the manufacture of optical data recording and storage media, there is an ongoing need for lower cost alloys with uniform sputtering characteristics and improved corrosion resistance that do not require the inclusion of more expensive precious metals. This need is met by the alloys of the present invention, whose properties make them especially suitable for use in optical data recording and storage media, in particular.

### SUMMARY OF THE INVENTION

Use of small amounts of samarium in alloys containing very high concentrations of silver have been shown to be very useful in the production of reflective and semi-reflective layers of optical media, as shown in my co-pending application published Mar. 11, 2004 under No. 20040048193, Lichtenberger et al. Now, however, I have also discovered a corresponding usefulness of samarium in copper based alloys used for the same purposes.

The present invention therefore is directed to optical data recording and storage media that include a reflective layer formed from a copper alloy comprising, in addition to copper, about 0.1 to about 3.0 wt. %, based on the total weight of alloy, of samarium (Sm), preferably about 0.3 wt. % samarium. Further according to the present invention, the alloy may also contain, in addition to the copper and samarium, about 0.1 to about 6.0 wt. %, based on the total weight of the alloy, of titanium (Ti), or more particularly about 0.5 wt. % titanium.

### BRIEF DESCRIPTION OF THE DRAWINGS

FIG. 1 is a schematic representation of an optical data storage disk that depicts two reflective layers, one of which is a thin semi-reflective layer, and their positions in the disk.

FIG. 2 is a schematic representation of pits and lands corresponding to digital data recorded on an optical data storage disk, together with a reflective signal produced by this layer.

FIG. 3 is a graph showing the reflectivity of metallic silver, aluminum, rhodium, platinum, copper and gold over the visible spectrum of light.

FIG. 4 is a schematic illustration of an electrical signal as it is read from an optical media storage disk.

FIG. 5 is an illustration of the data tracks in CD and DVD optical media formats.

### DETAILED DESCRIPTION OF THE INVENTION

Pure copper has satisfactory reflectivity but insufficient corrosion resistance to be used as the reflective and/or semi-reflective layer in optical media. I have found that the addition of small amounts of certain readily oxidizable metals, in particular, the rare earth metal samarium (Sm), to copper can improve its corrosion resistance while maintaining its desirable reflectivity, thereby providing a desirable material for use in reflective layers of optical recording and storage media.

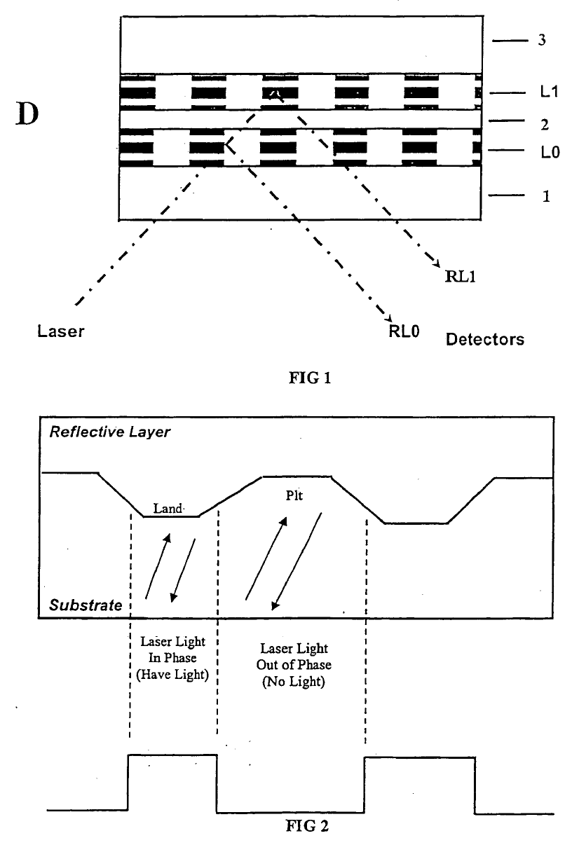

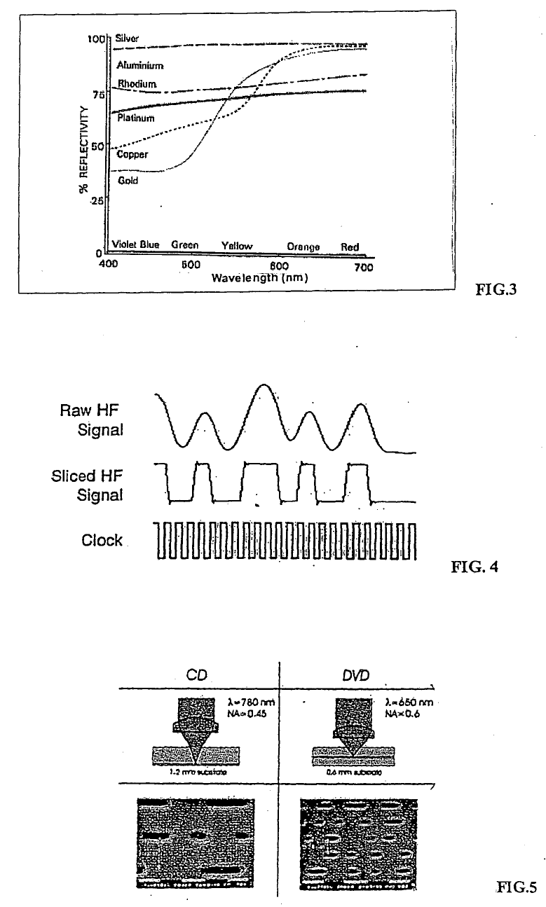

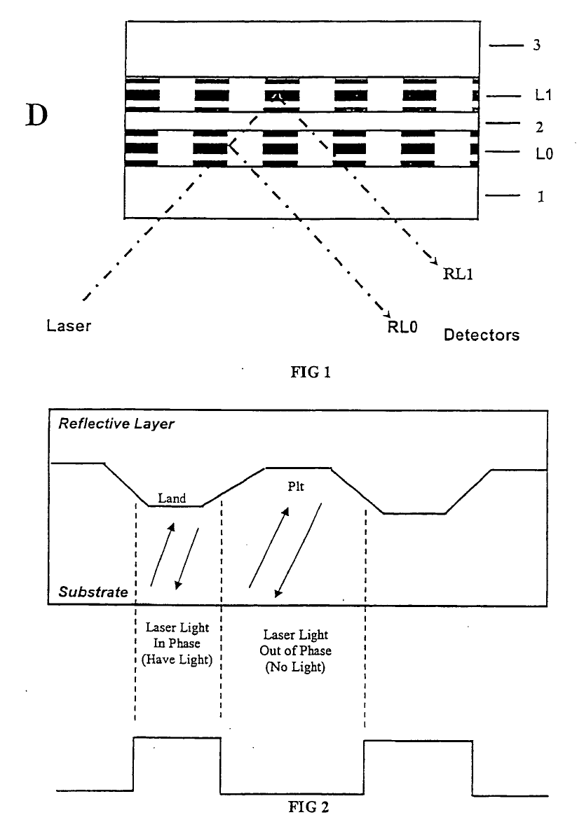

FIG. 1 schematically depicts an optical data storage disk D containing highly reflective layer L1 and semi-reflective layer L0. Either or both reflective layer L1 L0 may be formed from a copper alloy of the present invention. Light from a laser source that is reflected from layer L1 is designated RL1; similarly, light reflected from layer L0 is designated RL0. The reflected light RL1 and RL0 is sensed by detectors. It should be noted that the light from a laser source must penetrate the semi-reflective layer L0 twice in order to read layer L1.

In disk D, layers 1 and 3, which typically are formed from a plastic such as polycarbonate or poly(methyl methacrylate) (PMMA), are imprinted with digital information comprising pits and lands. Layer 2 is an adhesive layer, typically comprising a UV-curable epoxy material, that is used to join layers 1 and 3.

FIG. 2 schematically illustrates the digital interpretation of the information stored on optical data disk D. The lands are at a distance from the laser and the detector such that reflected signals return to the detector in phase (bright), while the pits are at a second distance such that the signal returns to the detector out of phase (dark).

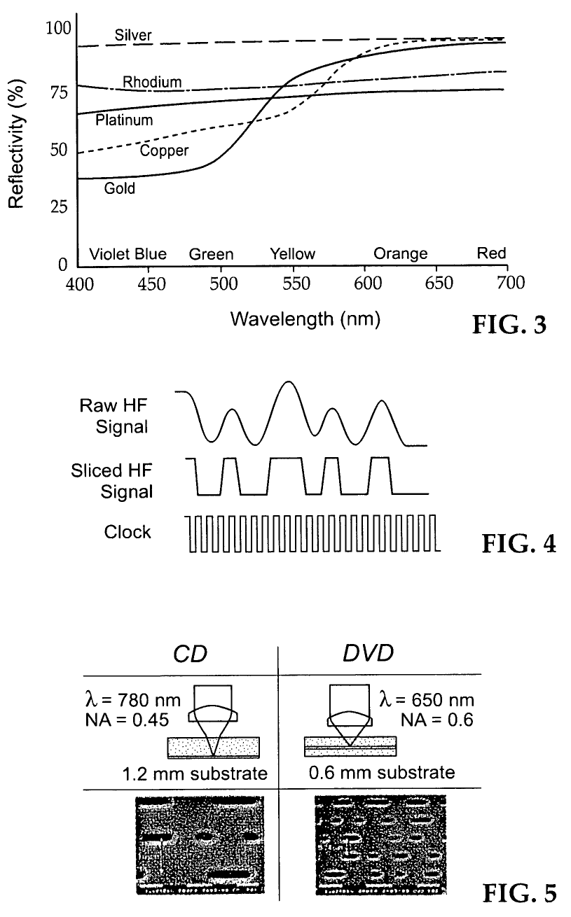

FIG. 3 shows the reflectivity of several other important metals—silver, aluminum, and gold—over the visible spectrum of light. Most optical data disks are read with light waves approximately 650 nm, in the red portion of the visible spectrum. More recently, however, blue light-emitting laser diodes have become commercially available, which enables the storage and reading of much denser data.

FIG. 4 illustrates the sinusoidal electrical signal read from an optical media storage disk that depicts how it is truncated and compared to an internal clock to decipher the pulse length and data contained on the disk.

FIG. 5 is an illustration of the data tracks and pits used for data storage in CD and DVD optical media formats. Optical data recording and storage disks having highly reflective and/or semi-reflective layers formed from copper alloys of the present invention can be used at least in these formats.

Corrosion resistant copper based alloys are formed, in accordance with the present invention, by the inclusion of about 0.1 to about 3.0 wt. %, preferably about 0.2 to about 0.3 wt. %, based on the total weight of alloy, of the rare earth metal samarium (Sm). The high solubility of samarium (Sm) compared to other reactive rare earth metals enables it to be added in relatively large amounts of the metal without the formation of secondary phases, which can become particulates during sputtering and cause defects in the reflective coating. A multiphase alloy may sputter as a single-phase layer, but if the coated layer is not stable as a single-phase material, then thermal exposure can cause the precipitation of the second phase, and this too will result in defects, particularly under harsh test conditions. For example, separation of a rare earth metal phase in a copper alloy reflective layer may create dark spots and cause errors in the optical data.

In addition to exhibiting good copper solubility, it is also desirable that the added rare earth metal exhibit high reactivity to air. The inclusion in copper alloys of samarium (Sm), which is highly reactive, has been found to produce a highly protective effect compared with pure copper in optical media that are subjected to stringent environmental testing.

Among the rare earth metals having high reactivity, samarium (Sm) is believed to have the highest solubility in copper. Also, as a consequence of its high reactivity, addition of small amounts of samarium (Sm) provides desirably high corrosion resistance.

Titanium (Ti), while it may not add substantially to corrosion resistance, has good solubility when used, e.g., at 0.5 wt. %, in copper, and can also be optionally included in the copper alloys of the present invention because of its scavenging effect during melting and alloying. It also acts as a grain refiner during rolling and annealing of the cast alloy ingots used to make the sputtering targets. The amount of titanium (Ti) included in the alloys is preferably about 0.1 to about 6.0 wt. %, more preferably, about 0.1 to about 0.5 wt. %, based on the total weight of the alloy.

Highly reflective layers and/or semi-reflective layers can be formed from the alloys of the present invention by sputtering techniques well known in the art. The following examples of useful copper alloys are presented to illustrate the scope of the invention:

### EXAMPLE 1

### A Copper Based Alloy Containing About 3.0 wt. % Sm

### EXAMPLE 2

### A Copper Based Alloy Containing About 1.0 wt. % Sm

### EXAMPLE 3

### A Copper Based Alloy Containing About 0.5 wt. % Sm and About 0.5 wt. % Ti

Optical media of the present invention, which include, respectively, 1.0 and 0.25 wt. % samarium (Sm) in the copper semi-reflective layer, are expected to produce passing results in all three of the standard industry tests conditions.

Similar passing test results can be expected for the present invention, in which the copper alloys contain, in addition to samarium (Sm) about 0.1 to about 0.5 wt. % titanium (Ti). The inclusion of samarium (Sm) at levels of preferably up to about 0.3 wt. %, an titanium (Ti) in amounts preferably up to about 0.5 wt. %, in the samarium (Sm)-containing copper alloys should enhance the benefit.

Of course, in refining the constituents copper, samarium and titanium, certain native impurities may still be present, but the presence of such native impurities in total amounts not exceeding 0.5 wt. % should not affect the performance of the invention.

The invention has been described in detail with particular reference to certain preferred embodiments thereof, but it is understood that variations and modifications can be effected within the spirit and scope of the invention, which is defined by the claims that follow.

What is claimed is:

1. An optical data recording and storage medium that includes at least one reflective layer formed from a copper alloy, based on the total weight of alloy, comprising at least about 90.0 wt. % copper (Cu) and from about 0.1 to about 3.0 wt. % of samarium (Sm).

2. The optical data recording and storage medium of claim 1 wherein copper alloy comprises from about 0.1 to about 0.3 wt. %, based on the total weight of alloy, of samarium (Sm).

3. The optical data recording and storage medium of claim 1 wherein copper alloy further comprises titanium (Ti).

4. The optical data recording and storage medium of claim 3 wherein copper alloy comprises from about 0.1 to about 5.0 wt. % titanium (Ti).

5. The optical data recording and storage medium of claim 3 wherein copper alloy comprises from about 0.1 to about 1.0 wt. % titanium (Ti).

6. An optical data recording and storage medium that includes at least one reflective layer formed from a copper alloy, consisting essentially of from about 0.1 to about 3.0 wt. % of samarium (Sm), less than about 0.5 wt. % impurities native to refined copper and/or samarium, and the balance copper (Cu).

7. The optical data recording and storage medium of claim 6, in which the alloy further consists of from about 0.1 to about 5.0 wt. % titanium (Ti), with the impurities native to the copper, samarium and/or titanium.

8. The optical data recording and storage medium of claim 7, in which the alloy consists of from about 0.1 to about 0.3 wt. % samarium and from about 0.1 to about 1.0 wt. % titanium (Ti).

9. A copper alloy comprising copper and from about 0.1 to about 3.0 wt. %, based on the total weight of alloy, of samarium (Sm).

10. The copper alloy of claim 9 comprising from about 0.1 to about 0.3 wt. %, based on the total weight of alloy, of samarium (Sm).

11. The copper alloy of claim 9 further comprising from about 0.1 to about 5.0 wt. % titanium (Ti).

12. The copper alloy of claim 11 further comprising from about 0.1 to about 0.5 wt. % titanium (Ti).

13. A copper alloy consisting essentially of, based on the total weight of alloy, from about 0.1 to about 3.0 wt. %, of samarium (Sm), from about 0.1 to about 5.0 wt. % titanium (Ti), less than about 0.5 wt. % impurities native to refined samarium, titanium and/or copper, and the balance copper (Cu).

14. The copper alloy of claim 13 in which the samarium consists of from about 0.1 to about 0.3 wt. % and the titanium consists of from about 0.1 to about 0.5 wt. %.
